(19) United States
(12) Patent Application Publication
(10) Pub. No.: US 2010/0274546 A1
(43) Pub. Date: Oct. 28, 2010

(54) METHODS AND SYSTEMS OF PLANNING A PROCEDURE FOR CLEANING A WELLBORE

(76) Inventors: Mohammad Zafari, Weastern Australia (AU); Younes Jalali, Beijing (CN); Yunlong Liu, Beijing (CN); Lan Lu, Houston, TX (US)

Correspondence Address: SCHLUMBERGER OILFIELD SERVICES, 200 GILLINGHAM LANE, MD 200-9, SUGAR LAND, TX, 77478, US

(21) Appl. No.: 12/669,199

(22) PCT Filed: Jul. 25, 2008
(86) PCT No.: PCT/US08/71211

§ 371 Date: Jun. 29, 2010

Related U.S. Application Data
(60) Provisional application No. 60/961,938, filed on Jul. 25, 2007.

(51) Int. Cl. G06G 7/48; E21B 37/00

(52) U.S. Cl. 703/10; 166/311; 703/10

(57) ABSTRACT

A method of planning a procedure for cleaning a wellbore by injecting a cleaning fluid from a reservoir into the wellbore includes detecting properties and conditions of fluids circulating between the reservoir and the wellbore; preparing a data set from the detected properties and conditions of the fluids circulating between the reservoir and the wellbore; simulating a cleaning operation model of injecting the cleaning fluid into the wellbore based on the data set; determining parameter settings of the simulated cleaning operation model that satisfy prescribed constraints; and producing the procedure for cleaning the wellbore based on the determined parameters. A system for conducting a procedure for cleaning a wellbore includes a sensor unit; a control unit; and a cleanup simulation system.

### FIELD OF THE INVENTION

Embodiments of the present invention relate to methods and systems of planning a procedure for cleaning a wellbore, and, in particular, methods and systems applying simulation models prior to designing a procedure.

### BACKGROUND OF INVENTION

During the drilling of a wellbore, various fluids are typically used in the well for a variety of functions. The fluids may be circulated through a drill pipe and drill bit into the wellbore and, then, may subsequently flow upward through wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

One way of protecting the formation is by forming a filter cake on the surface of the subterranean formation. Filter cakes are formed when particles suspended in a wellbore fluid coat and plug the pores in the subterranean formation such that the filter cake prevents or reduces both the loss of fluids into the formation and the influx of fluids present in the formation. A number of ways of forming filter cakes are known in the art, including the use of bridging particles, cuttings created by the drilling process, polymeric additives, and precipitates.

After drilling/completion of a well and before start of production, all the foreign fluids, such as drilling mud, are to be removed from the wellbore and the invaded zone around the wellbore. The cleaning operation is conducted in the very early period of production right after opening a well to remove all the contaminated fluids from the wellbore and the formation in vicinity of the wellbore. A common technique to clean a well is to start producing from the well until the percentage of contaminates in produced formation fluid is negligible. However, there are still some problems associated with these techniques. For example, there are various certain and uncertain factors that may influence the efficiency of the cleanup process, for example, physical and chemical properties and conditions of the fluids and the sidewall of the wellbore, and interaction therebetween. These properties and conditions include temperature, pressure, viscosity, pH of the fluid in the well, and the like. Furthermore, the degradation process of the filter cake is not easily controllable, particularly in situ. Because the internal and external factors are not always stable in the natural environment, precisely understanding and controlling the factors is frequently difficult.

### SUMMARY OF INVENTION

In one aspect, embodiments disclosed herein relate to a method of planning a procedure for cleaning a wellbore by injecting a cleaning fluid from a reservoir into the wellbore comprising: detecting properties and conditions of fluids circulating between the reservoir and the wellbore; preparing a data set from the detected properties and conditions of the fluids circulating between the reservoir and the wellbore; simulating a cleaning operation model of injecting the cleaning fluid into the wellbore based on the data set; determining parameter settings of the simulated cleaning operation model that satisfy prescribed constraints; and producing the procedure for cleaning the wellbore based on the determined parameters.

In one aspect, embodiments disclosed herein relate a system for cleaning a wellbore by injecting a cleaning fluid from a reservoir into the wellbore such that the cleaning fluid circulates between the reservoir and the wellbore comprising: a sensor unit that detects properties and conditions of fluids circulating between the reservoir and the wellbore; a control unit that prepares a data set from the detected properties and conditions of the fluids circulating between the reservoir and the wellbore; and a cleanup simulation system that performs: simulating a cleaning operation model of injecting the cleaning fluid into the wellbore based on the data set; determining parameter settings of the simulated cleaning operation model that satisfy prescribed constraints; and producing the procedure for cleaning the wellbore based on the determined parameters.

Other aspects and advantages of the invention will be apparent from the following description and the appended claims.

### BRIEF DESCRIPTION OF DRAWINGS

FIG. 1 is a schematic drawing of a typical drilling system.

FIG. 2 is a block diagram of a cleanup simulator system and a control unit in accordance with one embodiment of the present invention.

FIG. 3 is a flow chart showing a cleanup procedure of a wellbore in accordance with one embodiment of the present invention.

FIG. 4 is a flow chart showing an optimization procedure of a cleanup plan in accordance with one embodiment of the present invention.

FIG. 5 is a flow chart showing an optimization procedure of a cleanup plan performed during a job execution in accordance with one embodiment of the present invention.

### DETAILED DESCRIPTION

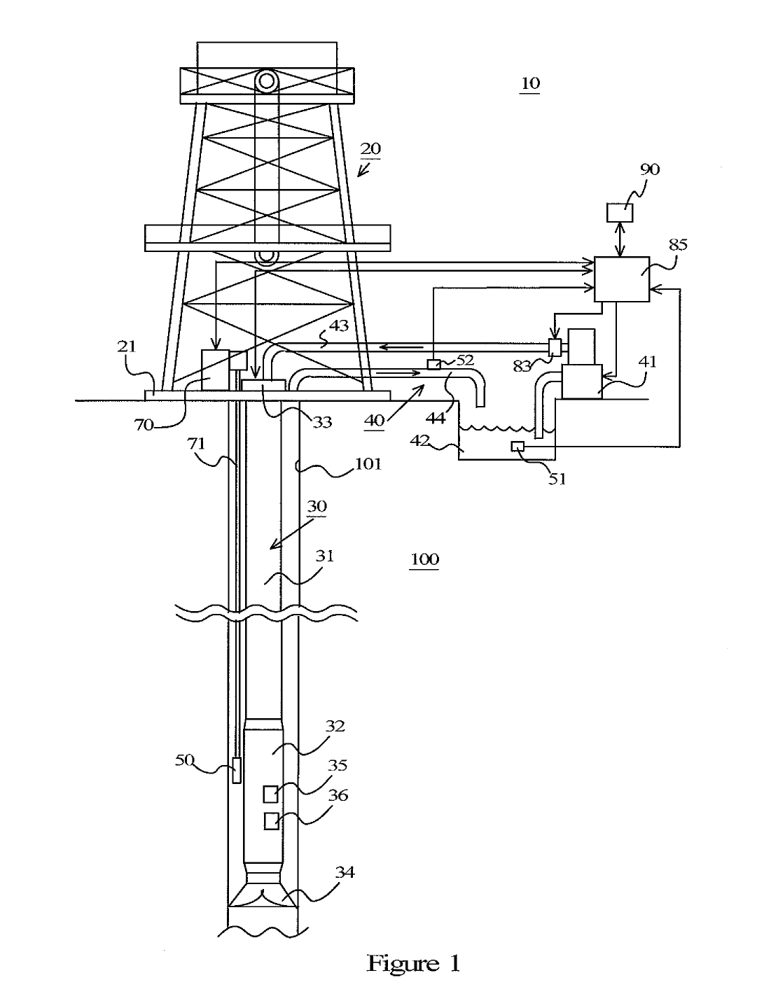

Referring initially to FIG. 1, a schematic drawing of a typical drilling system is shown. A drilling system 10 is provided for drilling a wellbore into an earth formation 100 to exploit natural resources, such as oil. The drilling system 10 includes a derrick 20, a drill string assembly 30, a fluid circulation system 40, a sensor unit 50, a winch unit 70, a control unit (data providing unit) 85, and a cleanup simulation system 90. The derrick 20 is built on a derrick floor 21 placed on the ground. Derrick 20 supports the drill string assembly 30, which is inserted into a wellbore 101 and carries on a drilling operation.

The drill string assembly 30 includes a drill pipe 31, a bottom hole assembly 32, and a drive system 33. The bottom hole assembly 32 is provided with a drill bit 34. The drill pipe 31, which has a hollow cylindrical structure, extends from drive system 33 to the bottom hole assembly 32. During an operation of drilling the wellbore 101, the drill pipe 31 is rotated by the drive system 33, and this rotation is transmitted through the bottom hole assembly 32 to the drill bit 34.

The fluid circulation system 40 includes a fluid pump 41, a reservoir 42, a supply line 43, and a return line 44. The fluid circulation system 40 circulates a drilling mud through the drill string assembly 30 and into the wellbore 101. Specifically, the fluid pump 41 pumps drilling mud, which is contained in the reservoir 42, out to the supply line 43 and, then, the drilling mud is injected into the drill pipe 31. The drilling mud injected into drill pipe 31 is then discharged from the drill bit 34 to the bottom of the wellbore 101 and returns to the reservoir 42 through the return line 44. An electrically-operated choke valve 83 adjusts the amount of the fluid flowing in the supply line 43.

After completion of the drilling operation, cleaning operations of the wellbore are performed to be remove contaminated fluids from the wellbore and the invaded zone around the wellbore. The cleaning operation is conducted in the very early period of production right after opening a well to remove all the contaminated fluids from the wellbore and the near wellbore region of the formation, by producing formation fluids, which pushes completion brine out of the wellbore and invasion zones of the formation. Thus, this cleaning stage may continue until the percentage of contaminants in the produced formation fluid is negligible.

The sensor units 50, 51, 52 detect properties and conditions of the fluids in the wellbore 101 and the fluid circulation system 40. Each sensor unit includes, for example, a thermometer, pressure sensor, a pH sensor, a redox (reduction/oxidation reaction) potential sensor, a viscosity sensor, a particle size sensor, a flow meter, and the like. The sensor unit 50 additionally includes a depth sensor. The sensor unit 50 is suspended in the wellbore 101 by a cable 71 to monitor the characteristics and conditions of the fluid in the wellbore 101. The winch unit 70 lifts the cable 71 to adjust depth position of the sensor unit 50 in the wellbore 101. The sensor unit 51 is placed in the reservoir 42 to monitor the characteristics and conditions of the fluid injected into the wellbore 101. The sensor unit 52 is placed on the return line 44 to monitor the characteristics and conditions of the fluid returning to the reservoir 42.

The control unit 85 monitors properties and conditions of the fluids in the wellbore 101 and the fluid circulation system 40. Also, the control unit 85 controls the operations of drilling and cleaning the wellbore 101 based on the monitored properties and conditions. The control unit 85 includes, for example, a central processing unit (CPU), a read only memory (ROM), a random access memory (RAM), input/output ports, memory, and the like. The control unit 85 is electrically connected to the drive system 33, a downhole pump 35, a gas lift valve 36, a fluid pump 41, the winch unit 70, the sensor units 50, 51, 52, and the cleanup simulation system 90. The control unit 85 operates the drive system 33, a fluid pump 41, the winch unit 70, and the choke valve 83 for drilling and cleaning the wellbore 101 according to preset programs and various detection signals from the sensor units 50, 51, 52. The downhole pump 35 and the gas lift valve 36 may be adjusted by the control unit 85 during the cleanup operation.

Further, the control unit 85 bi-directionally communicates with the cleanup simulation system 90. Specifically, the control unit 85 stores information relating to the properties and conditions of the fluids in the wellbore 101 and the fluid circulation system 40, and provides the stored information to the cleanup simulation system 90. The cleanup simulation system performs various types of simulations for cleaning the wellbore 101 using the information provided by the control unit 85, and designs an optimized procedure of cleaning the wellbore 101. According to the optimized cleaning procedure, the control unit 85 edits and/or modifies the preset programs for a cleaning operation of the wellbore 101 by controlling the drive system 33, the fluid pump 41, the winch unit 70, the choke valve 83, and the like.

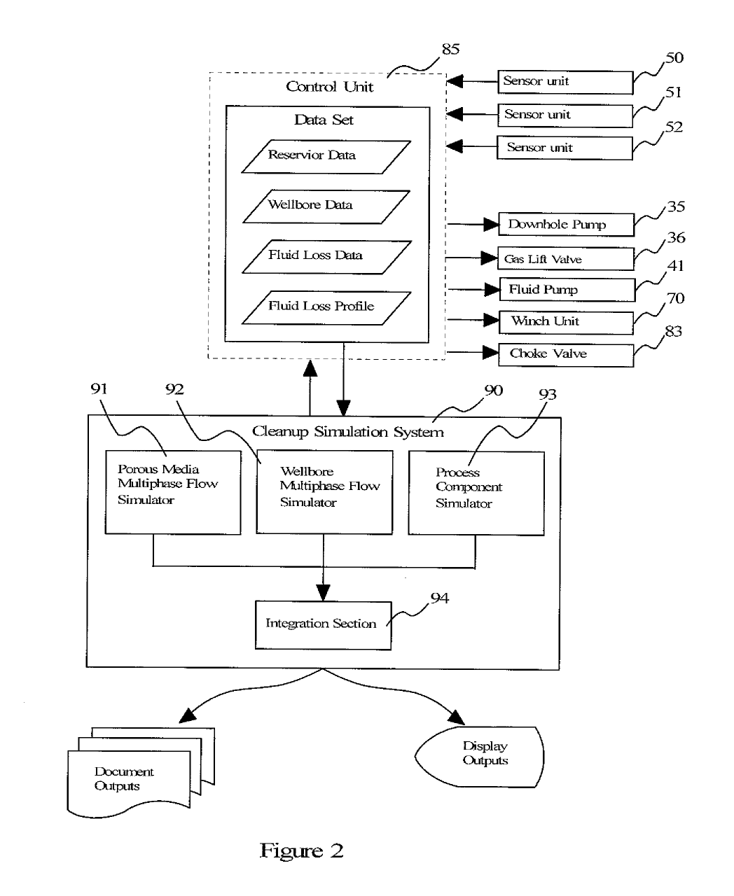

Referring now to FIG. 2, a block diagram of a cleanup simulation system 90 and control unit 85 is shown. The control unit 85 processes information received from the sensor units 50, 51, 52, and converts the information into appropriate data sets for the simulations by the cleanup simulation system 90. The cleanup simulation system 90 receives the data sets from the control unit 85, and performs simulations relating to property changes of the fluid in the wellbore 101 during the cleaning operation. The simulation result is fed back to the control unit 85. The control unit 85 conducts an optimized cleaning operation of the wellbore 101 according to the simulation result from the cleanup simulation system 90.

The data sets prepared in the control unit 85 are categorized into four groups comprising reservoir data, wellbore data, fluid loss data, and a fluid loss profile. The reservoir data represents parameters related to properties of the fluid existing in the reservoir at the initial stage of the cleaning operation, and properties of the reservoir itself. The reservoir data includes, for example, reservoir geometry, rock and fluid properties, initial state of the reservoir at the time of simulation, and the like.

The wellbore data represents parameters related to the geometry and trajectory of the wellbore, and characteristics and locations of devices inside the wellbore, such as the drill string assembly 30, and devices on the surface, such as the supply line 43 and the return line 44. The type of completion and the way that the reservoir is exposed to the wellbore can also be used as the wellbore data.

The fluid loss data mostly includes volumetric historical information collected during the drilling and completion period, which relates to the amount of fluid lost into the formation. This information is used to mark the depths and locations where there has been a considerable amount of fluid loss. This information is also used to estimate the total amount of foreign fluid expected to return to the surface from the formation.

The fluid loss profile includes measurements of fluid loss along the wellbore. The fluid loss profile can be obtained by direct measurements inside the wellbore. These measurements can be conducted, for example, by obtaining resistivity logs, which express the radius of the invaded zone around the wellbore.

The cleanup simulation system 90 includes a porous media multiphase flow simulator 91, a wellbore multiphase simulator 92, and a process component simulator 93, and an integration section 94. The simulator 91, 92, or 93 stores feasible models for simulating dynamic states of fluids with simulation objects. Each model is a function, in which a dependent variable (the simulation object) is a fluid property (for example, the density of the cleaning fluid) and independent variables are various factors that influence dynamic states of the fluid during the cleaning operation. When constructing the feasible models, uncertainty parameters, which possibly influence the dynamic states of the fluid during the cleaning operation, may also be included. The uncertainty parameters can be updated after the simulations.

For example, the porous media multiphase flow simulator 91 is designed to simulate a multiphase fluid flow in porous media. Specifically, the simulator 91 simulates the interaction between the foreign fluid (the fluid flowing into the reservoir through the return line 40) and the fluid in the reservoir 42. The dependent variables of the function in the simulator 91 are dynamic states of the two fluids in the reservoir, and the independent variables are temperature, pressure, and the like in the reservoir 42. Accordingly, the simulator 91 is able to model the fluid flow in different pressure and temperature conditions. Further, the simulator 91 is particularly able to model the multiphase fluid flow with high accuracy around the wellbore and contact regions of phases.

The wellbore multiphase simulator 92 is designed to simulate a multiphase flow of the fluids in a wellbore. The wellbore and the porous media are modeled interactively to represent the fluid flow from the reservoir to the wellbore and from the wellbore into the reservoir at all times.

The process component simulator 93 is designed to simulate how process components throughout the flowline influence the pressure and temperature in the fluid circulation system 40. The process components include, for example, the supply line 43, return line 44, the choke valve 83, the fluid pump 41, and any other components of the fluid circulation system 40, which may significantly influence the pressure and/or temperature thereof.

Integration section 94 integrates simulation results from all of the simulation models by the simulator 91, 92, 93. The integration result by the section 94 may include a time profile in concentration of the cleaning fluid inside the wellbore during the cleaning operation with the most preferable parameter settings from the perspective of cost efficiency, time efficiency, and the like. The set parameters may include a pumping rate of the fluid pump 41, opening degree of the choke valve 83 during the cleaning operation, concentration of the cleaning fluid reserved in the reservoir 42 at the initial stage of the cleaning operation, and the like. Further, the integration section 94 constructs a cleaning operation program based on the integration result.

The cleanup simulation system 90 displays the simulation results from the simulators 91, 92, 93, and the integration result from the integration section 94 for job monitoring purposes, and prints the results as documents to be used for scenario selection and optimization algorithms.

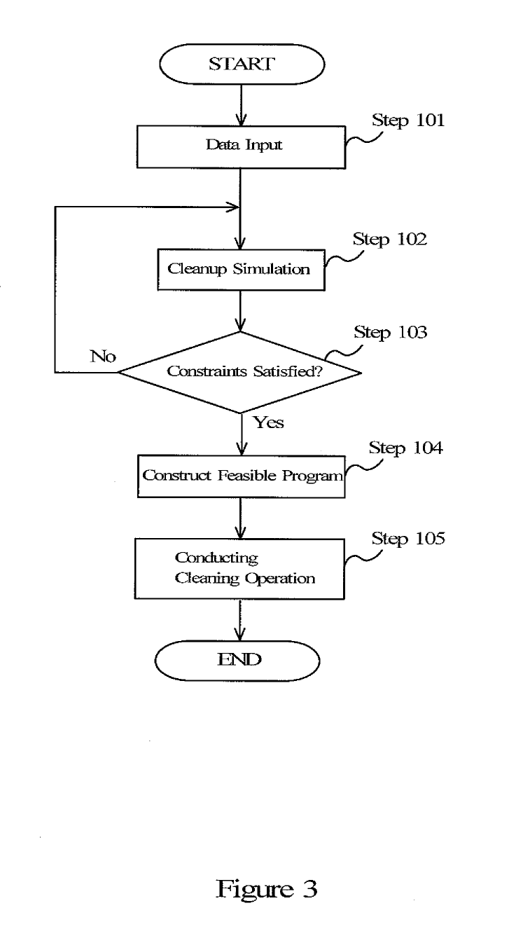

Referring now to FIG. 3, a wellbore cleaning procedure is shown in a flow chart. In the cleaning procedure, the fluid and the filter cake in the wellbore 101 are cleaned by the cleaning fluid supplied from the reservoir 42.

At Step 101 of the process, the control unit 85 prepares data sets based on the information from sensor units 50, 51, 52, and inputs the data sets into the cleanup simulation system 90.

At Step 102, using the data sets received from the control unit 85, the cleanup simulation system 90 performs the simulations to find the most preferable parameter settings for the cleaning operation from the perspective of cost efficiency, time efficiency, and the like.

At Step 103, the cleanup simulation system 90 evaluates whether the parameter settings obtained at Step 102 satisfy prescribed constraints. If the evaluation result is positive, at Step 104, the cleanup simulation system 90 constructs a cleaning operation program based on the simulation model with the most preferable parameter settings, which were obtained at Step 102. If the evaluation result is negative, by returning Step 102, the cleanup simulation system 90 re-performs the simulation model with alternative parameter settings so that the simulation result satisfies the constraints. The constraints may be categorized into completion constraints and production constraints. Regarding the completion constraints, the maximum drawdown needed to produce from the formation will be known. The maximum drawdown is governed by the maximum drawdown that the downhole completion can handle. For example, in the case of a gravel-packed completion, there is a maximum drawdown that one can apply in the bottom hole. That is, there is a maximum drawdown that can be applied on the formation to prevent collapsing the well. Other production issues, such as sand production for unconsolidated formations, can be considered.

Regarding the production constraints, the minimum bottom hole pressure to lift the cushion fluid to the surface will be known. This leads to whether there is a need for any artificial lift systems or whether the well will flow naturally. The minimum flow rates that can prevent the cushion fluids from slipping back down to the bottom hole are calculated during the simulation. This is a very important factor in ensuring that all the foreign fluids have been removed from the wellbore. Water coning and gas coning can be studied before performing the real operation. For each scenario, the possibility of water/gas coning is analyzed to prevent major damage to the productivity of the well.

Finally, at Step 105, the control unit 85 conducts the cleaning operation of the wellbore 101 by running the cleaning operation program.

Based on the above procedure, the control unit 85 and the cleanup simulation system in accordance with one or more embodiments of the present invention cooperate with each other so as to design the most preferable plan for a cleaning operation of the wellbore 101 after completion of the drilling operation. For example, the maximum flow rate that needs to be handled on the surface or downhole for any particular cleanup plan will be known. This will be used to select the appropriate cleanup facilities for any particular cleanup scenario. Further, duration of cleaning operation, which is some of the most important information that one can achieve by simulation of cleanup process for any particular well, can be precisely estimated.

The cleanup simulation system 90 in accordance with one or more embodiments can be used to select the optimum cleaning procedure to decrease the duration of operation. Minimization of cleanup duration is done with an optimization algorithm to assure the quality of the job. As noted before, the quality can be reflected by the amount of fluid abandoned inside the formation and also the final predictability of the wellbore right after the cleaning operation.

Further, the cleanup simulations can be operated independent from the drilling system described in the above embodiments. For example, the cleanup simulations referring to the porous media multiphase flow model, the wellbore multiphase flow model, the process components model, or any combination thereof, can be performed based on data sets including the reservoir data, the wellbore data, the fluid loss data, the fluid loss profile, or any combination thereof. An appropriate cleanup plan for a wellbore can be advantageously scheduled and/or modified according to the simulation results.

Furthermore, the simulation results can be used in many different ways during cleanup. For example, the simulation results can be used to ensure that the planned cleanup is successful in removing the contaminations from the wellbore vicinity. That is, assuming that a satisfactory estimation of the initial profile of the fluid lost into the formation was obtained, by modeling the cleanup process, it is possible to have a good estimation of the fluid loss profile around the wellbore after the cleaning operation has finished. Accordingly, the simulation results can be used as quality control for the cleaning operation. This is particularly important as fluid fractions on the surface are not always a good indication of a successful cleanup job. Even after achieving a negligible value of basic sediment and water, it is possible to leave a large amount of foreign fluids inside the formation.

The cleanup simulation system in accordance with one or more embodiments of the present invention is capable of determining a cleanup plan having the highest cleanup efficiency during the cleaning operation. Based on the type of formation and the type of completion, different scenarios are proposed to perform the cleaning operation. In another example, based on the reservoir properties of each section of well, a schedule for start of production from each interval can be determined. The amount of fluid lost in each interval is also a major factor during the selective cleanup planning.

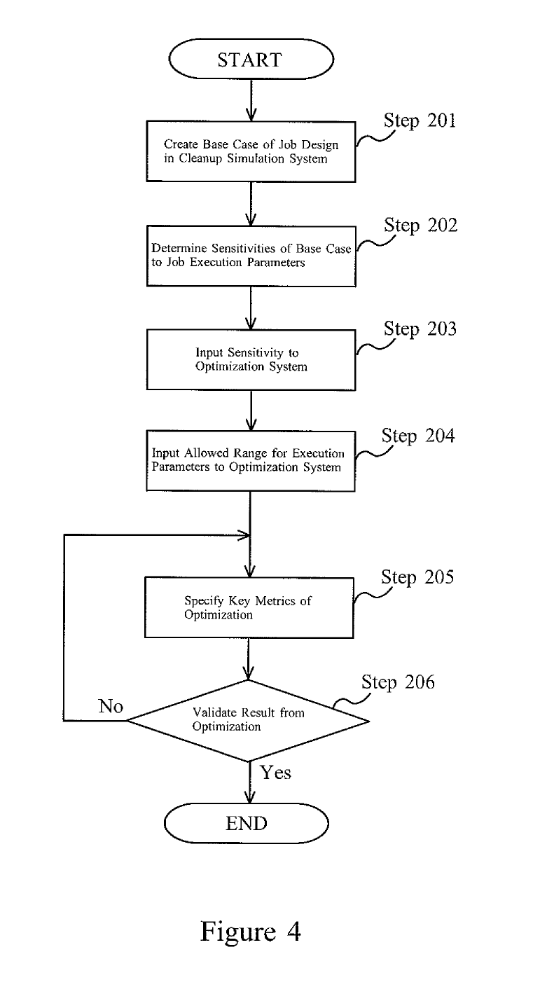

Further, the cleanup plan created based on, for example, the above process may be optimized by an additional optimization procedure. Referring to FIG. 4, a flow chart is shown of an optimization procedure of a cleanup plan. At Step 201 of the process, a base case of job design is created by the clean up simulation system 90. At Step 202 of the process, sensitivities of the base case to job execution parameters are determined. The sensitivities may include, for example, sensitivity of job duration or cleanup efficiency to choke size, choke sequence, and choke duration, etc. At Step 203 of the process, the above sensitivity information is input to the optimization system. At Step 204 of the process, an allowed range for each execution parameter is input to the optimization system. The ranges are specified as, for example, the minimum and maximum values of choke sizes, and wellhead pressures, etc. At Step 205 of the process, the key metrics of the optimization are specified. The key metrics may be related to technical, operational, and financial issues, such as technical and operational efficiencies, and cost minimization, respectively. At Step 206 of the process, the results from the optimization may be validated by the cleanup simulation system 90, for example, to ensure that the results are not biased for local minima. At the end of the process, an optimized plan for a job execution (actual cleanup operation) is obtained.

Further, all of the studies that have been done during the planning of the operation may be validated in real time during the cleaning operation. This validation is done in two ways. First, different scenarios can be chosen based on the uncertainty of the parameters that have been used during the simulation and plan study. Second, based on the feedback from the measurements during the cleaning operation, the behavior of the wellbore can be checked against the simulation results and the closest scenario is used for the remainder of the process.

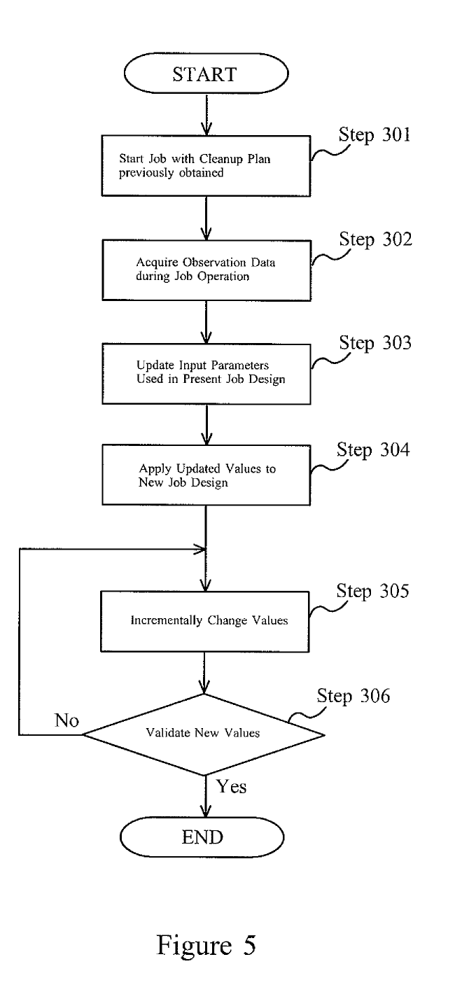

For example, referring now to FIG. 5, a flow chart is shown of an optimization procedure of a cleanup plan performed during a job execution. At Step 301 of the process, a job (actual cleanup operation) is started with the cleanup plan that was obtained previously. At Step 302 of the process, during the operation, observation data are acquired, for example, based on downhole and surface measurements of various parameters, such as rates, cuts, pressures, and Pit Volume Totalizer (PVT), etc. At operationally feasible time intervals, the measurement results are used to update the input parameters used in the present job design (Step 303). For example, if the observed value of fluid density is different from the value applied to the previous simulation, the observed value will be applied to the next simulation as an updated value for the parameter. At Step 304 of the process, updated values for the input parameters are applied to a new job design. At Steps 305-306 of the process, incremental adjustments (preset value change in one adjustment step) may be made to move the execution from the previous values to new values for the input parameters. After the incremental change at Step 305, the changed value is validated at Step 306. Such an incremental change process continues until no further adjustments are needed (for example, until the measurement values are consistent with the input value). The above optimization procedure is repeated until job completion criteria are satisfied. Such criteria may be defined as allowable values for recovery % of non-reservoir fluid loss in drilling and completion, the concentration of the non-reservoir fluids in well effluent, job duration, and the like.

Advantages of one or more embodiments of the present invention may include one or more of the following. One or more embodiments provide a method for planning a procedure for cleaning the wellbore based on results from various types of simulation models, which refer to factors that influence the efficiency of the cleaning process. One or more embodiments allow cleanup procedure cost and time savings to be realized. One or more embodiments involve not only designing a cleaning operation procedure using a preset facility, but also, involve designing a cleaning procedure for a wellbore that includes actually re-designing the facilities, such as a choke valve, a supply line, a return line, and the like, of the drilling system.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of planning a procedure for cleaning a wellbore by injecting a cleaning fluid from a reservoir into the wellbore comprising:
detecting properties and conditions of fluids circulating between the reservoir and the wellbore;
preparing a data set from the detected properties and conditions of the fluids circulating between the reservoir and the wellbore;
simulating a cleaning operation model of injecting the cleaning fluid into the wellbore based on the data set;
determining parameter settings of the simulated cleaning operation model that satisfy prescribed constraints; and
producing the procedure for cleaning the wellbore based on the determined parameters.

2. The method of claim 1, wherein the data set comprises at least one of reservoir data, wellbore data, fluid loss data, and a fluid loss profile.

3. The method of claim 1, wherein the properties and conditions of the fluids circulating between the reservoir and the wellbore is detected in the reservoir.

4. The method of claim 1, wherein the properties and conditions of the fluids circulating between the reservoir and the wellbore is detected in the wellbore.

5. The method of claim 1, wherein the detected properties and conditions comprise at least one of temperature, pressure, pH, reduction/oxidation reaction potential, viscosity, particle size, fluid flow rate, and depth.

6. The method of claim 1, wherein the cleaning operation model is designed based on a multiphase fluid flow in porous media contacting fluids circulating between the reservoir and the wellbore.

7. The method of claim 1, wherein the cleaning operation model is designed based on an interaction between a fluid existing in the reservoir and a fluid returning to the reservoir.

8. The method of claim 1, wherein the cleaning operation model is designed based on an interaction between a fluid existing in the wellbore and a fluid flowing into the wellbore during the cleaning operation.

9. The method of claim 1, wherein the cleaning operation model is designed based on physical conditions on devices used for the cleaning operation, wherein the physical conditions comprise at least one of temperature and pressure.

10. The method of claim 1, wherein the cleaning operation model is designed based on an influence of the dynamic state of the circulating fluid during the cleaning operation.

11. The method of claim 1, further comprising conducting the produced procedure for cleaning the wellbore and monitoring properties and conditions of fluids circulating between the reservoir and the wellbore during the cleaning procedure.

12. The method of claim 1, further comprising a process of optimizing the simulated cleaning operation model by changing at least one of the determined parameters based on the simulated cleaning operation model previously obtained.

13. The method of claim 12, wherein the process of optimizing the simulated cleaning operation model is performed during an actual operation of cleaning the wellbore applying previously determined parameters.

14. A system for conducting a procedure for cleaning a wellbore by injecting a cleaning fluid from a reservoir into the wellbore such that the cleaning fluid circulates between the reservoir and the wellbore comprising:
a sensor unit that detects properties and conditions of fluids circulating between the reservoir and the wellbore;
a control unit that prepares a data set from the detected properties and conditions of the fluids circulating between the reservoir and the wellbore; and
a cleanup simulation system that performs:
simulating a cleaning operation model of injecting the cleaning fluid into the wellbore based on the data set;
determining parameter settings of the simulated cleaning operation model that satisfy prescribed constraints; and
producing the procedure for cleaning the wellbore based on the determined parameters.

15. The system of claim 14, wherein the data set comprises at least one of reservoir data, wellbore data, fluid loss data, and a fluid loss profile.

16. The system of claim 14, wherein the properties and conditions of the fluids circulating between the reservoir and the wellbore is detected in the reservoir.

17. The system of claim 14, wherein the properties and conditions of the fluids circulating between the reservoir and the wellbore is detected in the wellbore.

18. The system of claim 14, wherein the detected properties and conditions comprise at least one of temperature, pressure, pH, reduction/oxidation reaction potential, viscosity, particle size, fluid flow rate, and depth.

19. The system of claim 14, wherein the cleanup simulation system comprises a porous media multiphase flow simulator.

20. The system of claim 14, wherein the cleanup simulation system comprises a wellbore multiphase flow simulator.

21. The system of claim 14, wherein the cleanup simulation system comprises a process component simulator.

22. The system of claim 14, wherein the cleanup simulation system comprises an integration section.

23. The system of claim 14, wherein the control unit monitors properties and conditions of fluids circulating between the reservoir and the wellbore during the cleaning procedure and modifies the produced procedure based on the monitored properties and conditions.

24. The system of claim 14, wherein the cleanup simulation system further performs optimizing system for optimizing the simulated cleaning operation model by changing at least one of the determined parameters based on the simulated cleaning operation model previously obtained.

25. The system of claim 24, wherein the process of optimizing the simulated cleaning operation model is performed during an actual operation of cleaning the wellbore applying previously determined parameters.
